(19) United States
(12) Patent Application Publication
(10) Pub. No.: US 2012/0154711 A1
(43) Pub. Date: Jun. 21, 2012

(54) TRANSPARENT LIQUID CRYSTAL DISPLAY DEVICE

(76) Inventors: Jongsin Park, Seoul (KR); Sehong Park, Paju-si (KR)

(21) Appl. No.: 13/302,787

(22) Filed: Nov. 22, 2011

(30) Foreign Application Priority Data
Dec. 20, 2010 (KR) 10-2010-0130879

(51) Int. Cl. G02F 1/1335

(52) U.S. Cl. 349/62

(57) ABSTRACT

The present disclosure relates to a transparent liquid crystal display device. The present disclosure suggests a transparent liquid crystal display device comprising: a liquid crystal panel; an upper polarizer film disposed on a front side of the liquid crystal panel; a light guide disposed directly at a rear side of the liquid crystal panel; a light source including a red LED, a green LED and a blue LED disposed at one side of the light guide; a side polarizer film disposed between the light source and the light guide; and a reflective optical sheet disposed directly at a rear side of the light guide. The transparent liquid crystal display device according to the present disclosure has an enhanced transparent property and an enhanced color reproduction property, at the same time.

Pursuant to 35 U.S.C. §119(a), this application claims the benefit of earlier filing date and right of priority to Korean Application 10-2010-0130879, filed on Dec. 20, 2010, the content of which is incorporated by reference herein in its entirety.

### BACKGROUND

1. Field of the Invention

The present disclosure relates to a transparent liquid crystal display device. Especially, the present disclosure relates to a technique for enhancing the color quality and transparency quality in a transparent liquid crystal display device which can be in transparent glass state when it is not working while it can be used as a display device when it works.

2. Discussion of the Related Art

Nowadays, due to the characteristics of light weight, slim thickness, low consumption electric power, the liquid crystal display device (or, LCD) is widely applied more and more. The LCD is applied to the portable computer such as note book PC, the official automation devices, the audio/video devices, the advertizing display device for indoor or outdoor, and so on. The transmittive type LCD, the most used type, represents the video images by modulating the luminescence of the light incident from the backlight unit by controlling the electric field applied to the liquid crystal layer.

Radiating the light generated from the light source to the liquid crystal panel disposed between two polarization films, using the polarized light and the light reflection anisotropy of the liquid crystal material, and controlling the light transmittance rate, the LCD can represent the video images. Until now, the LCD is developed just as a display device, but it has not been developed as a multipurpose device in which it works as a display device as well as it works as another device.

Nowadays, there are some needs for the transparent liquid crystal display devices using as a display when the user wants to show video data or video information thereon, and for using a transparent glass when it is not working as a display device. The transparent liquid crystal display device should have enough transparent property for seeing objects through it, and enough color reproduction property (or ‘color gamut’) for displaying video image. Using currently developed technologies, there is no good transparent LCD having the both properties.

### BRIEF SUMMARY

A transparent liquid crystal display device comprises: a liquid crystal panel; an upper polarizer film disposed on a front side of the liquid crystal panel; a light guide disposed directly at a rear side of the liquid crystal panel; a light source including a red LED, a green LED and a blue LED disposed at one side of the light guide; a side polarizer film disposed between the light source and the light guide; and a reflective optical sheet disposed directly at a rear side of the light guide.

The transparent liquid crystal display device according to the present disclosure has an enhanced transparent property when it is not working as a display device. Furthermore, when it is working as a display device, the transparent liquid crystal display device according to the present disclosure has an enhanced color reproduction property. In other words, even though, the transparent property and the color reproduction property in the transparent LCD are the trade-off relationship in which any one property is enhance while the other would be degraded, the present disclosure suggests a transparent LCD having enhanced transparent property as well as the color reproduction property, as the same time.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is the perspective view illustrating the structure of a transparent liquid crystal display device according to the present disclosure.

FIG. 2 is the cross-sectional view illustrating the structure of the transparent liquid crystal display device cutting along the line I-I′ in the FIG. 1.

FIG. 3 is the graph illustrating the variations of the light intensity of the three primary light colors in the present disclosure.

FIG. 4 is the graph illustrating the variations of the color reproduction property in the present disclosure.

### DETAILED DESCRIPTION OF THE DRAWINGS AND THE PRESENTLY PREFERRED EMBODIMENTS

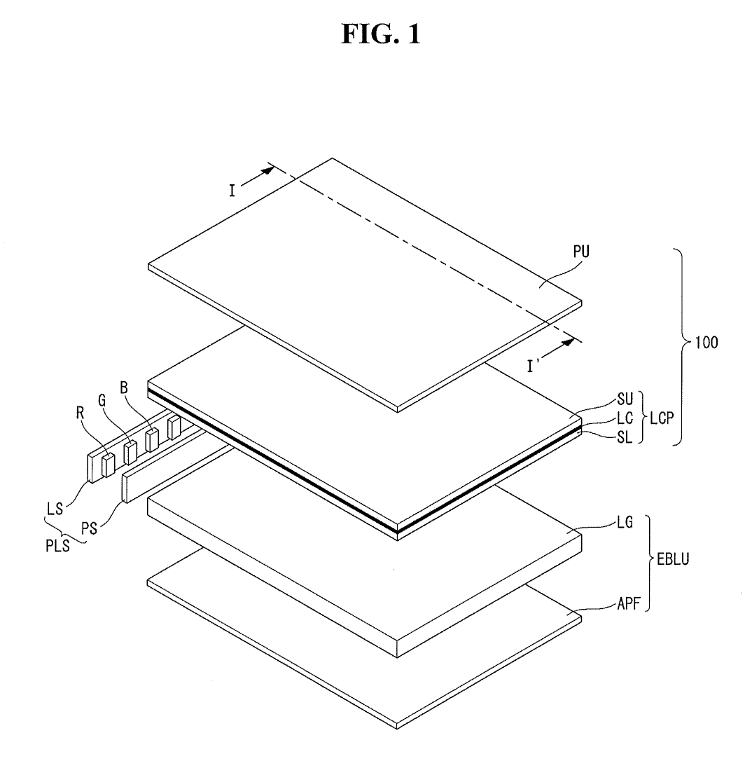

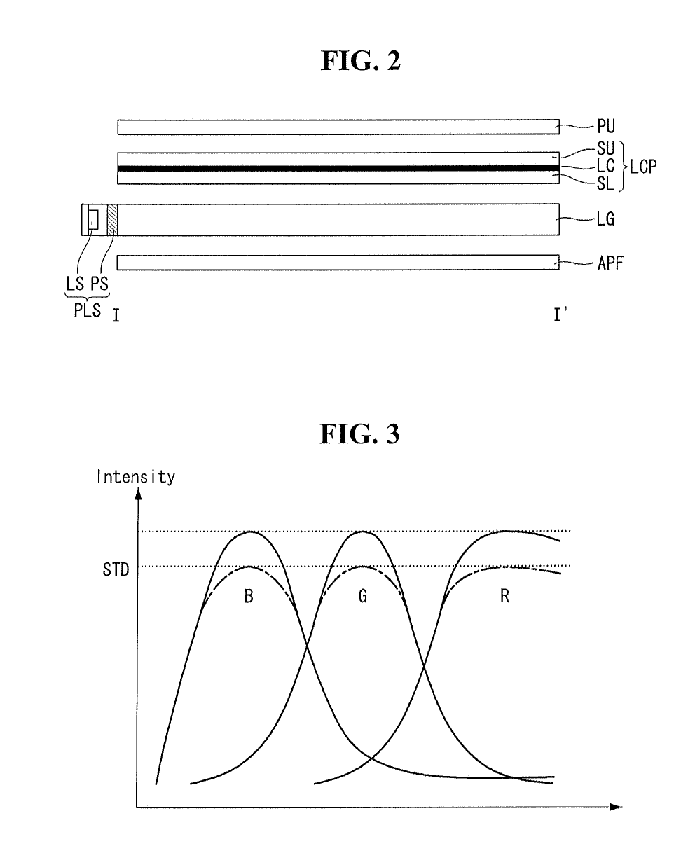

Hereinafter, referring to attached figures, we will explain preferred embodiments of the present disclosure. FIG. 1 is the perspective view illustrating the structure of a transparent liquid crystal display device according to the present disclosure. FIG. 2 is the cross-sectional view illustrating the structure of the transparent liquid crystal display device cutting along the line I-I′ in the FIG. 1.

Referring to FIGS. 1 and 2, the transparent LCD according to the present disclosure comprises a liquid crystal display panel 100 and an edge type back light unit EBLU. The liquid crystal display panel 100 includes a liquid crystal panel LCD and an upper polarizer PU.

The liquid crystal panel LCD includes an upper substrate SU, a lower substrate SL, and a liquid crystal layer LC sandwiched between the upper substrate SU and the lower substrate SL. Even though it is not shown in figures, on the upper substrate SU and the lower substrate SL, a plurality of lines and black matrix defining a plurality of pixel area disposed in matrix array, and a common electrode and a pixel electrode for driving the liquid crystal layer LC are formed. Especially, on the upper substrate SU further includes the color filters for representing full color.

Under the liquid crystal display panel 100, the edge type back light unit EBLU is disposed. The edge type back light unit EBLU includes a light guide LG, a polarized light source PLS disposed at one side of the light guide LG, and a reflective optical sheet APF disposed under the light guide LG.

The polarized light source PLS is disposed at one side of the light guide LG to radiate a linearly polarized light into the light guide LG. To do so, the polarized light source PLS includes a light source LS like the light emitting diode, and a side polarizer PS for polarizing the light from the light source linearly. Especially, the side polarizer PS is disposed to linearly polarize the light from the light source LS as being perpendicular to the light transmittance axis of the upper polarizer PU. This is for making a complete black grey scale when black is represented.

The light guide LG diffuses the linearly polarized light incident from the one side of the light guide LG into the whole space of the light guide LG, and refracts the light to the front side where the liquid crystal display panel 100 is disposed. To do so, a reflection pattern would be formed at the rear side of the light guide LG facing with the front side. Especially, as the light guide has to have enough transparent property, the reflection pattern has preferably any one type of the prism type, the lenticular lens type, or the micro lens type.

Under the light guide LG, the reflection optical sheet APF is disposed for reflecting some the linearly polarized light which may be lost through the rear side of the light guide LG, to the front side. This reflection optical sheet APF also has to have enough transparent property, so it would be made of a transparent material and it would be also an optical sheet having the light reflecting property in order to reflecting the linearly polarized light to the liquid crystal panel LCP.

The transparent liquid crystal display device explained above has different structure from the normal liquid crystal display device in which the liquid crystal panel LCP is disposed between two polarizing films of which light transmittance axis are perpendicularly crossed each other. Therefore, whether the liquid crystal panel LCP is working or not, all light incident from the back side of the liquid crystal panel LCP are passing to the front side of the liquid crystal panel LCP. That is, when the transparent liquid crystal display device according to the present disclosure can be set in normally white mode, the liquid crystal display panel 100 is in transparent state when it turns off or when it turns on in normal state.

In other case when the transparent liquid crystal display device according to the present disclosure can be set in normally black mode, the liquid crystal display panel 100 is in transparent state when it turns off or when it turns on in white mode. In the normally black mode, when light incident into the light guide LG is polarized perpendicular to the light transmittance axis of the upper polarizing film PU and there is no phase retardation at the liquid crystal panel LCP, the liquid crystal display panel 100 is in video data displaying state. Therefore, the transparent liquid crystal display device according to the present disclosure can be in normally black mode or in normally white mode.

In order to use this liquid crystal display device as a device using the transparent state, it is required to get higher transparency of this device enough seeing any object located behind this device through this device. That is, considering all elements effecting on the transparent property of this transparent liquid crystal display device, the maximum transparency should be ensured.

As mentioned above, the transparent liquid crystal display device having the structure shown in FIGS. 1 and 2 has enhanced high transparent property. There is one thing we have not considered for enhancing the transparent property, i.e. the color filter layer formed on the upper substrate SU of the liquid crystal panel LCP. The color filter layer comprises the red, green, and blue color filters. Any one color filter is occupied in each pixel area, and these three color filters are disposed alternately, like R-G-B order or R-B-G order.

As the color filter is for representing correct color of the video image data, the light intensity passing through the color filter will be lowered than before passing the color filter. That is, color filters are necessary elements for representing color image data, but in transparent state, they may degrade the light intensity of the light passing this display panel.

Therefore, it is required to increased the light intensity after passing through the color filter by controlling the characteristics of the color filter material. For the easiest method, the color filter can be made thinner and thinner. The thickness can be thinned until the color reproduction property of the light passing through the thinned color filter is satisfied in the standard color coordinate.

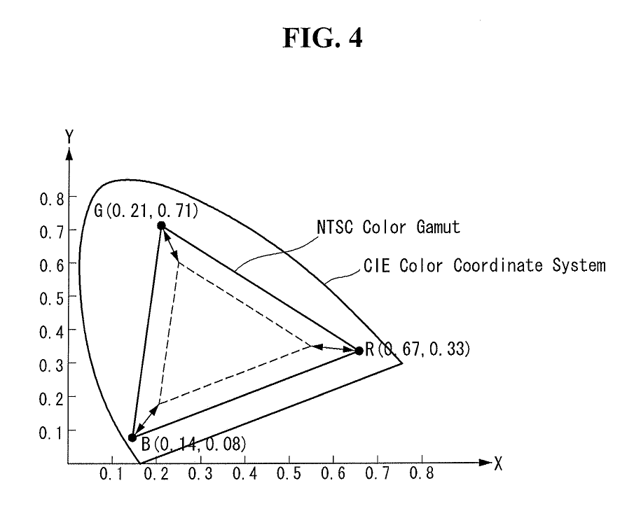

FIG. 3 is the graph illustrating the variations of the light intensity of the three primary light colors in the present disclosure. FIG. 4 is the graph illustrating the variations of the color reproduction property in the present disclosure. The dotted line labeled with STD in FIG. 3 represents the light intensity satisfying the NTSC color gamut after the white light is passing the color filter. The alternated long and short dash line in FIG. 3 means the standard light intensities of red, green and blue light. FIG. 4 represents the NTSC color gamut in the CIE color coordinate system. That is, the thickness of color filters can be defined by satisfying the NTSC color gamut shown as the solid line of the FIG. 4.

Furthermore, in order to ensure higher transparent property, the transparent liquid crystal display device according to the present disclosure includes color filters having a thickness about 50% thinner than thickness defined by the above mentioned method. The reason to do this is to get the condition in that, as shown in the solid line of the FIG. 3, the light intensity after a white light is passing through the color filter is enhanced about 30%˜about 40% than the light intensity satisfying the NTSC color gamut (referred as ‘STD’ in the FIG. 3).

In another method for increasing the transparent property, color resin materials having high transparent rate are used. In this case, thickness of color filter has not so critical limitation. It is enough for the color filter to have thinner thickness than the normal type liquid crystal display device. The color filter materials would have the high transparent property. Also, in this case, the light intensity after passing through the color filter has to have 30˜40% higher than the standard intensity. To select color filter materials having higher transparent property may cause the high cost, so that it is preferable method to make color filter be thinner.

When the thickness of the color filter is reduced to about 50% of the thickness of the other type liquid crystal display device, the transparent property is about 30% higher or more. However, the color reproduction property may be degraded.

The color reproduction property means the area of the triangle of RGB color coordinates. Good color reproduction means that the area of triangle is large in the CIE color coordinate system. The NTSC color gamut can be defined as the triangle of which three corners are R(0.67, 0.33), G(0.21, 0.71), and B(0.14, 0.08), and the area of this triangle is 0.158 in the CIE color coordinate system. The triangle shown as the dotted lines in FIG. 4 shows the changed triangle when the thicknesses of color filters are reduced about 50% to increase the transparent property. As shown as the solid line in FIG. 3, the light intensity will be increased, but the color reproduction property will be degraded. More specifically, when the thickness of the color filter is changed to have about 30˜about 40% higher light intensity as shown in FIG. 3, the area for the color reproduction property is reduced about 30%, as a result the area of triangle may be 0.110˜0.111.

That is, the liquid crystal panel according to the present disclosure includes a color filter where the triangle area representing a color reproduction property after a white light is passing the color filter is about 30% smaller than the triangle area representing the NTSC color gamut. In the present disclosure, in order to compensate the reduced color reproduction property due to the enhanced transparent property, the light source LS includes the red LED, the green LED and the blue LED. As a result, the area of the triangle shown as the dotted line in FIG. 4 can be recovered to the triangle shown as the solid line.

The liquid crystal panel according to the present disclosure includes a color filter satisfying the NTSC color gamut after the white light is passing through the color filter. Also, the color filter has the thickness about 50% thinner than the thickness of the color filter when the light intensity satisfies the NTSC color gamut. When the white LED is used as the light source LS, if the thickness of the color filter is reduced about 50% in order to enhance the transparent property, the color reproduction property will be degraded. However, using the red LED, green LED and the blue LED are used as the light source LS, the color reproduction property would not be degraded with keeping the enhanced transparent property. In the case that the light source LS consists of the red LED, green LED and blue LED, the brightness or luminescence may be not ensured. To overcome this failure, the light source LS further includes a white LED by adding to the combination of the red LED, green LED and blue LED.

In actual experiments, when the color filter has the thickness 50% thinner than other type liquid crystal display device, and the light source LS includes the red LED R, green LED G and the blue LED B, the color reproduction property is not degraded and the transparent property is increased 33% or more. Furthermore, when the light source LS includes the red LED R, the green LED G, the blue LED B and the white LED W, the brightness is further increased in 10%.

While the embodiment of the present invention has been described in detail with reference to the drawings, it will be understood by those skilled in the art that the invention can be implemented in other specific forms without changing the technical spirit or essential features of the invention. Therefore, it should be noted that the forgoing embodiments are merely illustrative in all aspects and are not to be construed as limiting the invention. The scope of the invention is defined by the appended claims rather than the detailed description of the invention. All changes or modifications or their equivalents made within the meanings and scope of the claims should be construed as falling within the scope of the invention.

1. A transparent liquid crystal display device comprising:
a liquid crystal panel;
an upper polarizer film disposed on a front side of the liquid crystal panel;
a light guide disposed directly at a rear side of the liquid crystal panel;
a light source including a red LED, a green LED and a blue LED disposed at one side of the light guide;
a side polarizer film disposed between the light source and the light guide; and
a reflective optical sheet disposed directly at a rear side of the light guide.

2. The device according to the claim 1, wherein the light source further includes a white LED.

3. The device according to the claim 1, wherein a light transmittance axis of the upper polarizer film is perpendicularly crossed with a light transmittance axis of the side polarizer film.

4. The device according to the claim 1, wherein the liquid crystal panel includes a color filter where a light intensity after a white light is passing through the color filter is enhanced about 30% to about 40% than a light intensity satisfying a NTSC color gamut.

5. The device according to the claim 1, wherein the liquid crystal panel includes a color filter where an area representing a color reproduction property after a white light is passing the color filter is about 30% smaller than a triangle area representing a NTSC color gamut.

6. The device according to the claim 1, wherein the liquid crystal panel includes a color filter satisfying a NTSC color gamut after a white light is passing through the color filter, and the color filter has a thickness about 50% thinner than a thickness of the color filter when a light intensity satisfies the NTSC color gamut.

7. The device according to the claim 1, wherein the liquid crystal panel further comprises:
an upper substrate;
a lower substrate; and
a liquid crystal layer disposed between the upper substrate and the lower substrate.
